(19) United States
(12) Patent Application Publication
(10) Pub. No.: US 2026/0253426 A1
(43) Pub. Date: Aug. 27, 2026

(54) SYSTEM AND METHOD FOR RECOGNIZING OBJECT BASED ON LIDAR AND ARTIFICIAL INTELLIGENCE TO REACT TO OCCLUSION EFFECT BY CROSSTALK NOISE

(71) Applicants: Hyundai Motor Company, Seoul (KR); Kia Corporation, Seoul (KR)

(72) Inventor: Ju Hyeok RA, Hwaseong-Si (KR)

(21) Appl. No.: 19/343,671

(22) Filed: Sep. 29, 2025

(30) Foreign Application Priority Data
Feb. 24, 2025 (KR) 10-2025-0023813

(51) Int. Cl. G06V 20/58; B60W 60/00; G06T 7/20; G06T 7/70

(52) U.S. Cl. CPC G06V 20/58; B60W 60/001; G06T 7/20; G06T 7/70

(57) ABSTRACT

A method performed by an apparatus of a vehicle may comprise generating, based on point cloud data from a sensor of the vehicle, a meta object, and associating the meta object with a previously detected object. The method may further comprise generating, based on a portion of the point cloud data affected by an occlusion effect, an occlusion meta object, and associating the occlusion meta object with the previously detected object. The method may also comprise updating, based on the associating of the meta object and the occlusion meta object, track data to track an object located ahead of the vehicle, outputting a signal indicating the updated track data, and controlling, based on the signal, autonomous driving of the vehicle.

### CROSS-REFERENCE TO RELATED APPLICATION

This application claims the benefit of priority to Korean Patent Application No. 10-2025-0023813, filed in the Korean Intellectual Property Office on Feb. 24, 2025, the entire contents of which are incorporated herein by reference.

### TECHNICAL FIELD

The present disclosure relates to a system and a method for recognizing an object based on light detection and ranging (LIDAR)-based simultaneous localization and mapping (SLAM) and artificial intelligence (AI) to react to an occlusion effect by crosstalk noise.

### BACKGROUND

The matters described in this Background section are only for enhancement of understanding of the background of the disclosure, and should not be taken as acknowledgment that they correspond to prior art already known to those skilled in the art.

Research on which object is present in front of a vehicle which is driving, on how far the distance between the object and the vehicle is, or on which algorithm the vehicle should respond according to for each specific situation to ensure safety is being conducted.

Thus, a vehicle sensor technology has become more advanced. There is a trend towards loading high-performance sensors, such as light detection and ranging (LiDAR) for recognizing a surrounding environment using laser beams, radio detection and ranging (RADAR) using radio waves, an ultrasonic sensor, a fisheye camera capable of capturing a 360-degree image, a multifocal lens, and a global positioning system (GPS), into the vehicle.

It is possible to aggregate the measured results obtained from the plurality of sensors to implement a super sensor vehicle. The concept of a super sensor in self-driving or autonomous driving refers to a technology for combining measured values of various sensors to more accurately recognize a surrounding environment, rather than relying on an individual sensor, for convenience or safety of vehicle driving. As information and communications technology (ICT) and cloud technology are added to this, a sensor necessary for autonomous driving and an AI algorithm associated with it are becoming more advanced than ever, for example, may remotely accumulate data in units of a fleet of vehicles, rather than targeting only one vehicle, and may train an AI server and a database to increase the confidence value of determination of the vehicle sensor.

Particularly, a LiDAR sensor for recognizing an external environment emits laser and measures the laser reflected from a surrounding object in terms of a time taken for reflection and laser intensity, thus recognizing various objects which are present on the road on which the vehicle is performing autonomous driving.

However, there are a plurality of traffic signs, each of which has large light reflectance, or a plurality of luminous objects for providing a notification of risk on the road in advance, on the real road. As such, an error in object tracking and recognition by LiDAR may occur due to the object with the large light reflectance. Although this is directly related to the safety of autonomous driving, there is a lack of a method capable of reacting to a noise phenomenon with certainty.

### SUMMARY

The present disclosure has been made to solve the above-mentioned problems.

An example of the present disclosure provides a system and a method for recognizing an object based on light detection and ranging (LiDAR)-based simultaneous localization and mapping (SLAM) and artificial intelligence (AI) to react to an occlusion effect by crosstalk noise to overcome the occlusion effect by the crosstalk using a meta object and an AI association operation for it.

The technical problems to be solved by the present disclosure are not limited to the aforementioned problems, and any other technical problems not mentioned herein will be clearly understood from the following description by those skilled in the art to which the present disclosure pertains.

The present disclosure may be implemented in the following various examples to address all or at least some of the above-mentioned technical problems.

According to the present disclosure, a method performed by an apparatus of a vehicle, the method may comprise, generating, based on point cloud data from a sensor of the vehicle, a meta object, associating the meta object with a previously detected object, generating, based on a portion of the point cloud data affected by an occlusion effect, an occlusion meta object, associating the occlusion meta object with the previously detected object, updating, based on the associating of the meta object and the associating of the occlusion meta object, track data to track an object located ahead of the vehicle, outputting a signal indicating the updated track data, and controlling, based on the signal, autonomous driving of the vehicle.

The method, wherein the generating of the occlusion meta object is performed based on a determination whether a tracking object is already designated as an update target, and wherein the generating of the occlusion meta object may comprise using an artificial intelligent algorithm to determine, based on noise in the point cloud data, whether the occlusion effect has occurred.

The method, wherein the generating of the occlusion meta object is performed further based on a determination whether a meta object associated with the tracking object is already present.

The method, wherein the generating of the occlusion meta object is performed further based on a determination whether a position of the tracking object corresponds to a position of a preceding vehicle, and wherein the determination of whether the position of the tracking object corresponds to the position of the preceding vehicle is made based on position information of an ego-vehicle equipped with a sensor.

The method, wherein the generating of the occlusion meta object is performed further based on a determination whether the ego-vehicle is driving straight.

The method, wherein the generating of the occlusion meta object may comprise, updating point information of a box representing the occlusion meta object, updating position and size information associated with the occlusion meta object, and initializing one or more flag information associated with the occlusion meta object.

The method, wherein the generating of the occlusion meta object may comprise determining a confidence value of the occlusion meta object.

The method, wherein the determining of the confidence value may comprise determining, a number of sensor points associated with the occlusion meta object, and setting, based on the number of sensor points, the confidence value.

The method, wherein the determining of the confidence value may comprise determining a position-based confidence value.

The method, wherein the determining of the confidence value may comprise determining a contour shape-based confidence value.

The method, wherein the determining of the confidence value may comprise an L-shape-based confidence value.

The method, wherein the determining of the confidence value may comprise determining, based on a z-score, a minimum point confidence value.

The method, wherein the associating of the occlusion meta object may comprise determining a degree of association based on a center point of the occlusion meta object and a center point of the previously detected object.

The method, wherein the associating of the occlusion meta object may comprise determining, based on a tracking point of the occlusion meta object, the degree of association.

The method, wherein the determining of the degree of association may comprise determining, based on an overlap region between the occlusion meta object and the previously detected object, the degree of association.

The method, wherein the associating of the occlusion meta object may comprise selecting, from among a plurality of previously detected objects, an associated object having a highest degree of association.

The method, wherein the selecting of the associated object having the highest degree of association may comprise selecting the associated object based on at least one criterion among, a width and length of the associated object, an area of the associated object, a height of the associated object, a number of points included the associated object, and a confidence value of the associated object satisfying a predetermined confidence value threshold, based on a number of meta candidate groups being greater than one.

According to the present disclosure, a vehicle may comprise, a sensor, a processor, and a memory storing at least one instruction that, when executed by the processor communicating with the memory, is configured to cause the vehicle to, obtain point cloud data generated by the sensor, based on a portion of the point cloud data affected by noise, generate an occlusion meta object, wherein the occlusion meta object represents a partially detected object located ahead of the vehicle, and wherein the noise is caused by signal interference from at least one object located in an area scanned by the sensor, determine whether the occlusion meta object satisfies predefined criteria, wherein the predefined criteria are based on at least a distance and orientation of the occlusion meta object relative to the vehicle, based on determining that the occlusion meta object satisfies the predefined criteria, associate the occlusion meta object with a tracking object, wherein the tracking object corresponds to a previously detected object, and wherein the tracking object is not currently associated with any previously generated occlusion meta object, and update, based on the associated occlusion meta object, tracking information of the tracking object such that the tracking object is tracked based on the updated tracking information, despite the noise.

The vehicle, wherein the noise may comprise crosstalk noise, wherein the at least one instruction, when executed by the processor communicating with the memory, is configured to cause the vehicle to, determine a confidence value of the occlusion meta object, wherein the confidence value is based on a number of sensor points in the portion of the point cloud data affected by the crosstalk noise, and wherein the determination of whether the occlusion meta object satisfies the predefined criteria is further based on the confidence value.

The vehicle, wherein the at least one instruction, when executed by the processor communicating with the memory, is configured to cause the vehicle to, associate the occlusion meta object with a tracking object by comparing position or size information of the occlusion meta object and the tracking object to determine whether the occlusion meta object corresponds to the same object as the tracking object, output a signal indicating the tracking information, and control, based on the signal, autonomous driving of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of the overall system for controlling a vehicle to automatically recognize an object and perform autonomous driving according to an example of the present disclosure;

FIG. 2 shows an example of a situation in which crosstalk noise to be solved in the present disclosure and an occlusion effect due to it occur;

FIG. 3 shows an example of a LiDAR and Ai-based object recognition algorithm for reacting to an occlusion effect by crosstalk noise according to the present disclosure;

FIG. 4A, FIG. 4B, FIG. 4C, and FIG. 4D show exemplary drawings for describing a scheme for performing an association operation with a track according to the present disclosure;

FIG. 5A shows an example of an error in object recognition due to crosstalk and an occlusion effect capable of occurring in the situation shown in FIG. 2;

FIG. 5B shows an exemplary drawing of an experimental result in which object tracking is normally performed despite crosstalk and an occlusion effect by applying the present disclosure in a similar situation to FIG. 5A; and

FIG. 6 shows an example of a computing system for autonomous vehicle control and object recognition computation according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature recognizing object in the presence of occlusion effect caused by crosstalk noise) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature recognizing object in the presence of occlusion effect caused by crosstalk noise) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature recognizing object in the presence of occlusion effect caused by crosstalk noise) described herein.

Minimum risk maneuver (MRM) operation(s) may also be controlled, for example, based on one or more features (e.g., feature recognizing object in the presence of occlusion effect caused by crosstalk noise) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature recognizing object in the presence of occlusion effect caused by crosstalk noise) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature recognizing object in the presence of occlusion effect caused by crosstalk noise) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature recognizing object in the presence of occlusion effect caused by crosstalk noise) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

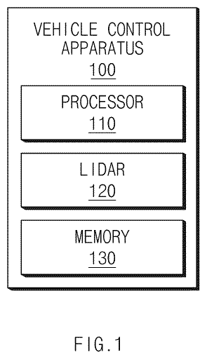

FIG. 1 shows an example of the overall system for controlling a vehicle to automatically recognize an object and perform autonomous driving according to an example of the present disclosure.

Referring to FIG. 1, a vehicle control apparatus 100 according to an example of the present disclosure may be implemented inside or outside a vehicle and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1 (e.g., a GPS module, a communication module, an inertial measurement unit (IMU), or an external camera, etc.).

The vehicle control apparatus 100 according to an example may include a processor 110, light detection and ranging (LiDAR) 120, and a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but an example is not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1 (e.g., excluding the memory 130, integrating the LiDAR 120 with the processor 110, or using only the processor 110 for minimal control operations, etc.).

The vehicle control apparatus 100 according to an example may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP) (e.g., a Snapdragon AP, an Exynos AP, or an Apple Silicon Soc, etc.). The processor 110 may have a structure of a single-core processor or may have a structure of a multi-core processor including a dual core, a quad core, a hexa-core, or an octa core (e.g., 2-core ARM Cortex-A55, 4-core Intel Atom, 8-core ARM Cortex-A78, etc.).

According to an example, the processor 110 may include at least one of a graphic processing unit (GPU) or a neural processing unit (NPU), or any combination thereof. For example, the GPU may be referred to as a visual processing unit (VPU) (e.g., Mali-G78, Adreno 740, or PowerVR GM9446, etc.). For example, the NPU may be referred to as a neural network processing unit (e.g., Google Edge TPU, Apple Neural Engine, or Samsung NPU, etc.).

The vehicle control apparatus 100 according to an example may include a depth sensor for detecting an external object. For example, the depth sensor for detecting the external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., a stereo camera, a millimeter-wave radar, a near-infrared depth camera, or a laser triangulation sensor, etc.). Hereinafter, a description will be given of LiDAR for convenience of description.

The vehicle control apparatus 100 according to an example may include the LiDAR 120 for obtaining a plurality of points based on a pulse laser signal. For example, the LiDAR 120 may obtain datasets for identifying a surrounding thing around the vehicle control apparatus 100 (or the vehicle including the vehicle control apparatus 100). For example, the LiDAR 120 may identify at least one of a position of the surrounding thing, a motion direction of the surrounding thing, or a speed of the surrounding thing, or any combination thereof, based on the fact that a pulse laser signal radiated from the LiDAR 120 is reflected from the surrounding thing and returns (e.g., detecting a nearby car's lateral velocity, a pedestrian's position, or the distance to a wall, etc.).

For example, the LiDAR 120 may obtain datasets representing an external object on a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a specified period (e.g., every 100 ms, 10 Hz, or 20 Hz, etc.). For example, the plurality of points may include points representing the external object in a three-dimensional (3D) virtual coordinate system. The 3D virtual coordinate system may include at least one of a vehicle coordinate system or a LiDAR coordinate system, or any combination thereof (e.g., body-fixed coordinates of the car, a local LiDAR sensor frame, or a fusion coordinate system, etc.). However, the example of the 3D virtual coordinate system is not limited to those described above.

The memory 130 of the vehicle control apparatus 100 according to an example may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM) (e.g., for temporarily storing sensor readings, preprocessed data, or software parameters, etc.).

For example, the volatile memory may include at least one of a dynamic RAM (DRAM), a static RAM (SRAM), a cache RAM, or a pseudo SRAM (PSRAM), or any combination thereof (e.g., LPDDR5 DRAM, L1/L2 cache, or mobile SRAM, etc.). For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., a 512 GB SSD, 64 GB eMMC, or onboard NOR flash, etc.).

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application (e.g., a real-time detection module, a sensor fusion engine, a LiDAR pre-processor, or a control decision loop, etc.).

Hereinafter, the phrase that the application is installed in the vehicle control apparatus 100 may mean that one or more instructions provided in the form of the application are stored in the memory 130, which may mean that the one or more instructions are stored in a format executable by the processor 110 of the vehicle control apparatus 100 (e.g., as a file with an extension specified by the operating system of the vehicle control apparatus 100) (e.g., as a file with an extension such as *.exe, *.bin, or *.img, depending on the operating system of the vehicle control apparatus 100, etc.).

For example, the memory 130 may include a first neural network model for detecting an object (e.g., YOLO, PointPillars, or CenterPoint, etc.). For example, the memory 130 may include a second neural network model for outputting a type of the plurality of points obtained by the LiDAR 120 and/or a score of the plurality of points (e.g., confidence score, semantic label, or intensity map, etc.).

In an example, the processor 110 may obtain at least one of a first virtual box for representing a target object or a first class indicating a type of the target object, or any combination thereof, based on the plurality of points obtained via the LiDAR 120 and the first neural network model stored in the memory 130 (e.g., generating a bounding box around a car and labeling it as a vehicle, etc.).

In an example, the processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100) (e.g., 30 meters ahead, within the drivable path, or near the blind spot, etc.). For example, the target object may include an object which identified by the vehicle control apparatus 100 and is continuously tracked. For example, the type of the target object may include a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof (e.g., pedestrian, car, truck, cyclist, animal, or construction cone, etc.).

In an example, the processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model (e.g., PointNet++, RangeNet++, or KPConv, etc.).

For example, the second neural network model may include a neural network model for obtaining the type of the plurality of points and the score of the plurality of points (e.g., semantic labels such as road, car, person, or obstacle, and corresponding confidence levels, etc.).

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points (e.g., vehicle, cyclist, pedestrian, or background, etc.).

According to an example, the processor 110 may perform a first specified algorithm for the plurality of points. For example, the processor 110 may perform the first specified algorithm for classifying the type of each of the plurality of points, for the plurality of points (e.g., distinguishing ground from non-ground points, etc.). For example, the processor 110 may classify second partial points corresponding to a specified type among the plurality of points. For example, the specified type may include a type representing the ground (e.g., road surface, pavement, or terrain, etc.).

For example, the processor 110 may classify the second partial points corresponding to the specified type, based on performing the first specified algorithm for the plurality of points, and may exclude the second partial points from the plurality of points to obtain (or identify) the first partial points (e.g., above-ground objects such as vehicles, barriers, or pedestrians, etc.).

In an example, the processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type (e.g., car, human, animal, tree, or road marking, etc.).

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object (e.g., forming a dense region of points that likely belong to a single physical object, etc.).

For example, the processor 110 may obtain a point cloud for generating a second virtual box, based on the first partial points (e.g., points corresponding to a portion of a pedestrian, a bicycle, a traffic cone, or a parked vehicle, etc.). For example, the processor 110 may obtain the point cloud, based on grouping the first partial points.

For example, the processor 110 may generate the second virtual box which is different from the first virtual box and is for representing the target object, based on the point cloud. For example, the second virtual box may include a box that encloses at least some of the first partial points (e.g., points on the front bumper, side mirror, or roofline of a car, etc.).

For example, the processor 110 may identify a heading direction indicating a travel direction of the target object, based on at least one of the first partial points or the point cloud, or any combination thereof (e.g., heading direction estimated from clustered points along the object's lateral axis).

For example, the processor 110 may identify a position of the second virtual box on the virtual coordinate system, based on the at least one of the first partial points or the point cloud, or the any combination thereof (e.g., using the bounding dimensions in the x, y, and z axes to define the width, height, and length). For example, the processor 110 may identify a size of the second virtual box, based on the at least one of the first partial points or the point cloud, or the any combination thereof (e.g., classifying the target as a pedestrian, cyclist, sedan, or truck, etc.). For example, the processor 110 may identify a second class, based on the at least one of the first partial points or the point cloud, or the any combination thereof. For example, the processor 110 may identify at least one of the heading direction indicating the travel direction of the target object, the position of the second virtual box on the virtual coordinate system, the size of the second virtual box, or the second class, or any combination thereof, based on the at least one of the first partial points or the point cloud, or the any combination thereof.

For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on at least one of the first virtual box, the first class, the heading direction of the second virtual box, the position of the second virtual box, the size of the second virtual box, or the second class, or any combination thereof. For example, the processor 110 may obtain a third class indicating the type of the target object corresponding to the bounding box, based on at least one of the first virtual box, the first class, the heading direction of the second virtual box, the position of the second virtual box, the size of the second virtual box, or the second class, or any combination thereof. For example, the processor 110 may obtain at least one of the heading direction of the bounding box, the position of the bounding box on the virtual coordinate system, or the third class indicating the type of the target object corresponding to the bounding box, or any combination thereof, based on the at least one of the first virtual box, the first class, the heading direction of the second virtual box, the position of the second virtual box, the size of the second virtual box, or the second class, or the any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box using the second identifier. For example, the processor 110 may track the target object, based on identifying a plurality of bounding boxes including the bounding box to which the second identifier is assigned, at a plurality of frames. For example, because the second identifier is an identifier assigned to the bounding box corresponding to the target object, the processor 110 may identify the plurality of bounding boxes to which the second identifier is assigned, at the plurality of frames, to track the target object.

In an example, the processor 110 may output the bounding box corresponding to the target object, based on at least one of the first virtual box, the first class, the first partial points, or the second class, or any combination thereof. For example, the bounding box may include an example of representing the target object on the virtual coordinate system in the form of a hexahedron (e.g., a cube, cuboid, or rectangular prism).

Hereinafter, a description will be given briefly of operations performed by the CPU, the GPU, and/or the NPU included in the processor 110.

According to an example, the processor 110 may include at least one of the CPU, the GPU, or the NPU, or any combination thereof. For example, at least one of the GPU or the NPU, or any combination thereof may obtain the first virtual box and the first class, based on the first neural network model (e.g., a convolutional neural network, a region proposal network, or a hybrid object detector). For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model. For example, the CPU may classify the second partial points corresponding to the specified type among the plurality of points, based on performing the first specified algorithm (e.g., rule-based filtering or threshold comparison) for classifying the type of each of the plurality of points for the plurality of points.

As described above, the vehicle control apparatus 100 according to an example may include the at least one processor 110. The vehicle control apparatus 100 may detect the target object using the at least one processor 110 to accurately detect the target object (e.g., a vehicle, a pedestrian, a traffic sign, or a tree, etc.). Furthermore, by performing a parallel process, the vehicle control apparatus 100 may reduce a load for each processor (e.g., CPU, GPU, or NPU, etc.).

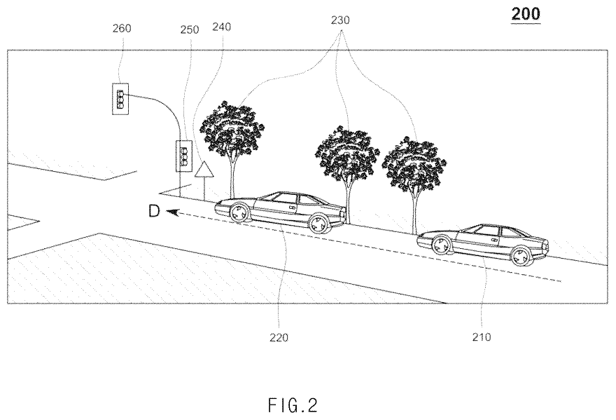

FIG. 2 shows an example of a road situation 200 in which crosstalk noise (e.g., reflections from metallic surfaces, overlapping signal paths, or environmental interference, etc.) to be solved in the present disclosure and an occlusion effect due to it occur.

Referring to FIG. 2, in FIG. 2, a vehicle 210 which is driving in a state in which LiDAR 120 is currently mounted is referred to as the ego-vehicle 210 or the host vehicle 210. In FIG. 2, a vehicle 220 which is driving by preceding the host vehicle 210 is referred to as a preceding vehicle or the preceding object 220 (e.g., another car, a truck, or a motorcycle, etc.).

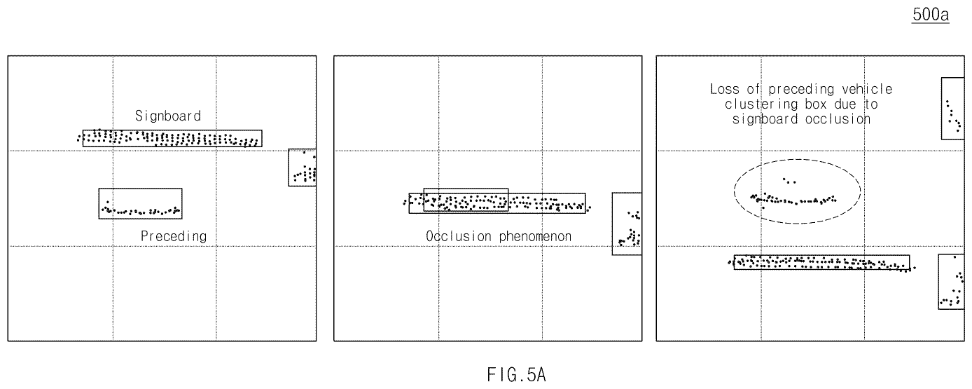

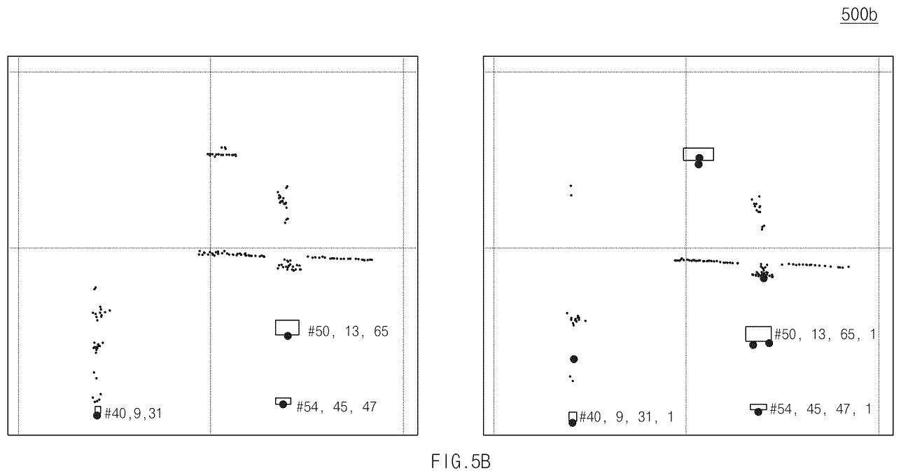

For example, as shown in FIGS. 5A and 5B which will be described below, the LiDAR 120 may perform point clustering of clustering points composed of a large number of points into a certain group and may recognize objects 210, 220, 230, 240, 250, and 260 on a road on which the host vehicle 210 performs autonomous driving. An AI module loaded into the processor 110 may generate, for example, a predicted bounding box (P-Box) capable of being checked in FIG. 5A and FIG. 5B for the automatically recognized object 220 or the like, based on the recognized sensor data of the LiDAR 120. This may be the basis of an automatic object recognition technology using the LiDAR 120 and an AI algorithm (e.g., a convolutional neural network, a region-based CNN, or a transformer-based detection model, etc.).

However, in FIG. 2, for example the objects, such as the street trees 230, do not usually reflect light, whereas objects, such as the traffic sign 240 or the traffic lights 250 and 260 made of metal, well reflect light. As described above, there is a need for time information (e.g., the time it takes for the emitted laser beam to bounce back) until the laser beam is reflected from object particles of the road to return after the LIDAR 120 emits the laser beam and intensity information about strength of the returned laser beam for the LiDAR 120 to recognize the object after emitting the laser beam and receiving the return signal from particles of the object on the road (e.g., vehicle surfaces, road signs, or infrastructure elements, etc.). If there are the objects 240, 250, and 260, each of which has a large light reflective index, on the road, Light and laser excessively reflected from the objects 240, 250, and 260 may be recognized by the LiDAR 120 mounted on the host vehicle 210. As if there is a false object in a horizontal direction of the traffic sign 240 or a vertical direction of the traffic lights 250 and 260, points may occur by the LiDAR 120 (e.g., leading to ghost targets, phantom reflections, or misclassified spatial points, etc.).

Such points are a recognized error of the LiDAR 120. However, P-Box tracking for the preceding vehicle 220 may fail in a process in which the Al algorithm recognizes an object based on point information input from the LiDAR 120. Such tracking failure usually occurs at a moment when the preceding vehicle 220 passes near or beneath highly reflective objects (e.g., traffic signs 240, traffic lights 250 and 260, or metallic poles, etc.). However, because of light excessively reflected from the light reflection objects 240, 250, and 260 even after the preceding vehicle 220 passes through the light reflection objects 240, 250, and 260, the LiDAR 120 may fail to recognize the presence of the preceding vehicle 220.

As such, a representative edge case which occurs according to the characteristic that the LiDAR 120 uses laser is referred to as crosstalk noise which occurs due to a reflected object. A phenomenon in which the preceding vehicle 220 is out of LiDAR tracking, which is present due to such noise, is referred to as an occlusion effect. If the street trees 230 are physically occluded such that the laser beam of the LiDAR 120 does not come into contact with the traffic lights 260 in FIG. 2, the traffic lights 260 may be a target of the occlusion effect by the street trees 230. However, the present disclosure regards the case in which the preceding vehicle 220 is occluded by crosstalk noise as posing a greater threat to the safety of autonomous driving, it proposes a system 1000 and an algorithm 300 for addressing it.

In other words, an area where occlusion does not occur is referred to as a free space. Because a load for an algorithm operation time occurs in a LiDAR point cloud and a P-Box-related AI computation and tracking process, a continuous update of object tracking and object recognition by AI is performed based on an object which is not occluded based on the free space (e.g., another vehicle or thing or the like located in a place regardless of direction D, a stationary object, a roadside barrier, or another moving vehicle, etc.).

If the occlusion effect occurs in a region which should be recognized as the free space, the preceding object 220 may be lost from tracking of the LiDAR 120 by the above-mentioned principle. As the lost time taken to fail in object tracking is longer, the shape of the preceding object 220 is recognized as being more inaccurate or measurement about a heading, a position, a speed, or the like of the preceding object may be more incorrect. If the preceding object 220 is a vehicle or a pedestrian, it is obvious that this increases the risk to autonomous driving safety, particularly during critical maneuvers (e.g., lane changes, emergency braking, or intersection crossing, etc.).

Particularly, if the traffic sign 240 or the traffic lights 250 and 260 (with relatively large light reflectance) (e.g., metallic road signs, overhead signals, or reflective billboards, etc.) are located within the route of the ego-vehicle 210 as shown in FIG. 2 and the preceding vehicle 220 is driving in front of the route, the frequency of occurrence of crosstalk in a horizontal or vertical direction by the traffic sign 240 or the traffic lights 250 and 260 increases. This may result in a phenomenon in which a meta object recognized as the preceding vehicle 220 is deleted from a LiDAR object recognition map, because crosstalk noise occurring when the preceding vehicle 220 passes through the position where there is/are the traffic sign 240 or the traffic lights 250 and 260 is added to LIDAR point data and the P-Box about the preceding vehicle 220.

Furthermore, even after the preceding vehicle 220 passes through, for example, the point where it overlaps with the traffic sign 240, crosstalk noise caused by the traffic sign 240 may occlude LiDAR sensing for a rear part of the preceding vehicle 220. In this case, there may occur a case in which meta object information about the preceding vehicle 220 is not tracked.

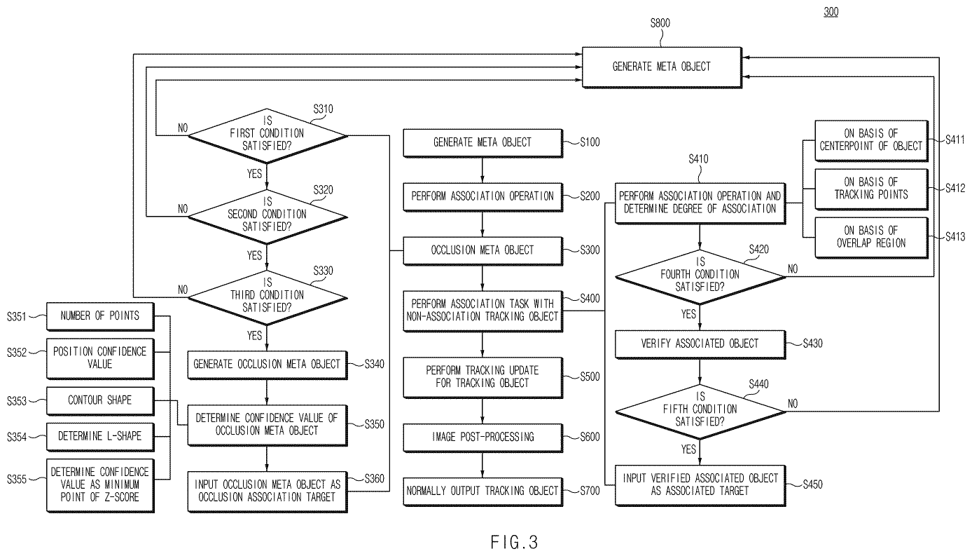

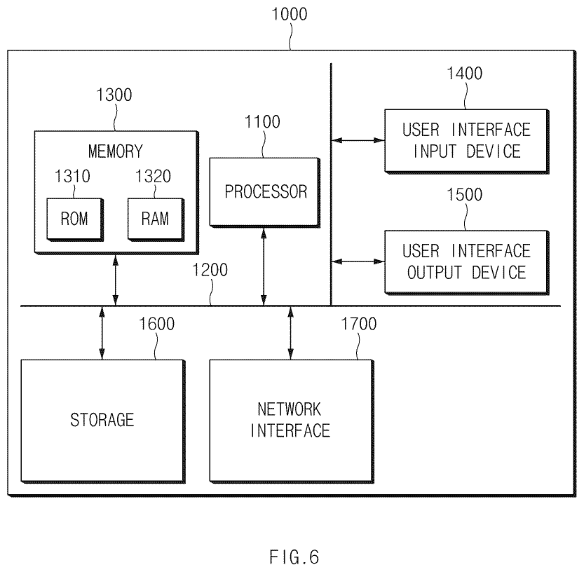

Next, FIG. 3 shows an example of a LiDAR and Ai-based object recognition algorithm 300 for addressing an occlusion effect by crosstalk noise according to the present disclosure. The Ai-based object recognition algorithm 300 may operate as a software module executed by a processor 110 of FIG. 1. The processor 110 may execute the algorithm 300 with reference to point cloud sensing information from LiDAR 120 and various pieces of data stored in a memory 130. Furthermore, the processor 110 may be a part of a computing system 1000 shown in FIG. 6. Thus, a LiDAR and Ai-based object recognition system 1000 for reacting to an occlusion effect by crosstalk noise according to the present disclosure may be substantially the same as the computing system 1000 shown in FIG. 6, which will be described below.

An object recognition process by the LiDAR 120 and an AI module passes through three steps, such as pre-processing, segmentation, and tracking. FIG. 3 synthetically illustrates the tracking step to which the present disclosure is applied.

Thus, there is a need for the overall description of a LIDAR object recognition process to understand the algorithm 300 according to the present disclosure, which is shown in FIG. 3. Hereinafter, a description will be given of the overall recognition process.

The object recognition system 1000 (refer to FIG. 6) according to the present disclosure may pass through pre-processing before performing object tracking of FIG. 3. The pre-processing may include, for example, an operation of converting laser sensing data (i.e., raw data) input from the LiDAR 120 into the appearance shown in FIG. 5B and removing points forming the ground. Because it is able to be misrecognized as if there is any object on the ground by the laser beam reflected from the ground, the process of separating the ground from non-ground objects (e.g., vehicles, pedestrians, poles, or barriers, etc.) may be performed in the pre-processing step.

For example, the pre-processing in AI object recognition is understood as a process in which an image processing tool of the AI module in the processor 110 removes noise of a LiDAR point cloud image (e.g., random stray reflections, surface clutter, or duplicate points, etc.), for example, reduces the total number of points which are present in the LiDAR point cloud image via a voxel downsampling technique or the like to promote computational efficiency.

For reference, a LiDAR point cloud image (e.g., refer to FIG. 5B) may be displayed in a bird's eye view (BEV) scheme (not shown). If a LiDAR map is made as if it were a bird's eye view of the city while the bird flies in the sky, this is referred to as a bird's eye view (BEV) image (not shown).

In other words, as described above, the LiDAR 120 transmits a laser beam to a surrounding environment and records a time when the laser beam is reflected from an object which is present in the outside to return, thus generating a point every many laser signals and calculating a distance to the point. By repeatedly transmitting a large number of laser beams, the processor 110 may generate a real-time LiDAR map (e.g., refer to FIG. 5B) (e.g., a 3D BEV map) for a surrounding environment (e.g., a 3D spatial layout of nearby vehicles, pedestrians, buildings, etc.) as a BEV type of three-dimensional (3D) map (not shown) and may generate it as a two-dimensional (2D) map as shown in an experimental result of FIG. 5B, which will be described below, if necessary.

The line or surface shown in black and white on the LiDAR point cloud map is actually composed of innumerable points (each of which is generated by the laser beam of the LiDAR 120). Due to this, a LiDAR sensing image is called a LIDAR point cloud image. Optionally, for example, if a red, green, blue-depth (RGB-D) sensor and the LiDAR sensor are combined with each other, the LiDAR point cloud image may be re-implemented in color (e.g., for more intuitive visualization in development tools or simulation environments).

While it may be difficult for humans to recognize a thing using only one of many points in the LiDAR point cloud image, when viewing the collective points synthetically from the BEV perspective—or similarly to a floor plan view as shown in FIG. 5B—it becomes easier to infer the shape and layout of the surrounding environment around the vehicle engaged in autonomous driving. For example, it becomes possible to recognize the vehicles 210 and 220, a bus, a pedestrian, the street trees 230, the traffic sign 240, or the like which is present in the LiDAR point cloud image. Such a thing or person is called an object in an AI image recognition technology. It is possible to classify the object as a class which belongs to a group of the specific nature, such as a vehicle class or a bus class.

The help of a deep AI neural network is required to classify whether any object in the LiDAR point cloud image is the vehicle class or the bus class. AI training should precede to find the objects 210 to 260 in the LiDAR point cloud image via the AI neural network and identify a class of the object. For example, a dataset called PANDASET™ includes more than 48,000 camera images (images captured primarily in the Silicon Valley region of the United States) and includes more than 16,000 LIDAR scam images. A total of 28 classes, such as pedestrians, cars, bicycles, construction site signs, and traffic signs, are arranged in the form of an annotation in these images.

Furthermore, the LiDAR point cloud image 210 may be visualized to suit an option desired by a user using a point cloud work tool, such as Open3D™. Because the LiDAR 120 is able to detect a distance, it may more realistically reproduce a 3D LiDAR image in such a manner as to display a thing in a long distance in, for example, a deep blue and display a thing in a short distance in a light blue, when the LiDAR point cloud image is visually processed using, for example, Open3D™.

In addition, the technology, for example, voxel (3D pixel) downsampling, may be applied to the LiDAR point cloud image to pre-process an original LiDAR image (i.e., raw data) in S100. Herein, the voxel refers to a 3D pixel in the shape of a regular hexahedron and the voxel downsampling is a technology for reducing the number of points not to require excessive AI computation, even while maintaining a structure of various objects included in the LiDAR point cloud (e.g., maintaining sufficient spatial resolution for accurate object recognition).

Meanwhile, the LiDAR 120 radiates, for example, m laser beams n times during one scan cycle. In this case, the scan value of the laser beam which collides with an external object to return constitutes an (m×n) matrix. This (m×n) matrix data is called a range image. Each point constituting the

LiDAR point cloud image may include depth (i.e., range) information and may further include intensity, an azimuth, an inclination, or the other additional information of the returned laser pulse. The range image is a large amount of datasets, for example, Waymo™ open dataset (WOD). It is possible to perform AI learning of the range image.

A range view (RV) refers to a technique for converting a 3D point cloud into a 2D scene, for example, 2.5D scene to represent the 3D point cloud as a 3D LiDAR map that humans are able to intuitively understand, Like an analog picture, rather than a large number of points. The 3D LiDAR point cloud image has 2D coordinates in the range view image, but the 3D laser-related information (e.g., the angle, the inclination, the intensity, and the Like) which is recorded when previously obtaining the range image is not discarded. If a variable called a width is applied to (x, y) coordinates among (x, y, z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm 300 according to the present disclosure may include a convolutional neural network (CNN). The CNN is an AI training module frequently used to extract a feature (or a feature point) (e.g., edges, textures, or key points) from image data. To this end, there is a dataset composed of tens of thousands of commercially available images. The CNN currently has a version capable of processing each of one-dimensional to three-dimensional images. In other words, the result of a range view image processing tool is learned by the CNN to perform a function of helping AI to accurately recognize an object in an image.

Because a thing present around an autonomous vehicle is finally recognized by a machine, the operation of generating a ground truth (GT) bounding box on the above-mentioned LiDAR map is also an important process in object recognition. Ground truth (GT) in machine learning is a term used when indicating an original value and a real value of data AI wants to learn. It may be usually viewed as a kind of image annotation overlaid on the LiDAR point cloud image as a bounding box with a box-shaped boundary.

In other words, the AI module fetches a label to group various objects to recognize the object. Of course, an interval of 3D data points used to output a GT bounding box may be set, which may be set such that about 50 to 1000 LiDAR point cloud points are included in one GT bounding box.

Of course, original (raw) data captured by sensors like LiDAR 120 during vehicle driving does not inherently include GT annotations. The processor 110 should recognize a target which belongs to various classes, such as the road sign 240 of the road, a crosswalk, a pedestrian, the other vehicle 220, lane markers, or a center line, as an object. The GT annotation may serve as a reference for comparing the objects recognized by the AI algorithm 300 with the actual environment, enabling performance evaluation and error measurement. A GT bounding box overlaid on the original image in the form of an annotation may be set manually by the user, but there is representatively a commercially available GT computation tool, such as grid-striding.

When the AI object recognition module is active, a predicted bounding box may be generated. The result of being recognized as an object of a specific class by the processor 110 from the original image data obtained from the LiDAR 120 or the like is represented in the form of another bounding box similar to the GT bounding box (e.g., in terms of length, width, size, shape, or position, etc.). The predicted bounding boxes are the result of being calculated by autonomous driving AI, which is different from the GT bounding box. The predicted bounding box may be identical to the GT bounding box, but may fail to be identical to the GT bounding box or may not at all have an area where the predicted bounding box and the GT bounding box over lap with each other (e.g., partially overlap or fail to overlap entirely).

For reference, because it is unable to conclude that an object of a specific class is actually present at a certain position definitely using only predicted bounding boxes, the predicted bounding boxes are usually called a probability box (P-Box) or a predicted bounding box (e.g., a vehicle detected with partial LiDAR points, a partially occluded pedestrian, or a roadside sign with ambiguous shape, etc.).

Segmentation processing performed after the pre-processing refers to displaying a specific portion (e.g., traffic lights, pedestrians, or lane markers, etc.) of the road in, for example, red and displaying the rest (bituminous road,, sidewalks, or grassy areas, etc.) in blue. Clustering the point cloud into a certain group to generate a P-Box may be performed in the segmentation step.

In other words, clustering based on the point cloud and P-Box generation proceed upon the segmentation processing. In the present disclosure, for example, a maximum of 500 P-Boxes with no occlusion effect may be output in the shape of a quadrangle or a hexahedron (e.g., bounding boxes around cars, bicycles, road signs, or traffic barrels, etc.) in S700 which will be described below.

For reference, semantic segmentation is a task for attaching a unique class label to respective points in the point cloud generated by the LiDAR 120. The semantic segmentation in a LIDAR imaging technology is a technology for finding and using meaningful information from LiDAR data for object recognition or scene representation necessary to implement autonomous driving. There are already various semantic segmentation AI modes, such as a projection-based method (e.g., RangeNet++, PointNet++, or KPConv, etc.), a point-based method, and a sparse convolution-based method. For example, the semantic segmentation result may be the AI computation result performed together with the NVIDIA DRIVE™ AGX system by the processor 110. Via such a configuration, various colors may be added to, for example, the LiDAR point cloud image to indicate object classes such as buses, pedestrians, traffic cones, or cyclists, etc.

Although, it will be described below, S600 of FIG. 3 indicates a post-processing process of a LiDAR image. The post-processing refers to converting point cloud data into a 3D map or modeling, which is information meaningful for autonomous driving. A process of finally removing noise from the LiDAR point cloud image or correcting an error in the LiDAR point cloud image, recognizing an object, such as a vehicle or a pedestrian, from the point cloud, and attaching and registering a unique identifier to the point cloud information if necessary is also included in the post-processing. Furthermore, determining whether the object moves or stops based on the object information and performing class classification (e.g., vehicle vs. pedestrian, moving vs. stationary, or obstacle vs. navigable area, etc.) may also be performed in S600.

If S600 of FIG. 3 ends, the result of tracking surrounding environment information in real time by the LiDAR 120 may be output by the processor 110 upon autonomous driving via S700. Particularly, in S700, the result of recognizing and tracking the LiDAR object may be generated based on information about a maximum of 70 tracking objects (e.g., vehicles, pedestrians, bicycles, or traffic cones, etc.) which will be described below.

Referring continuously to FIG. 3, a description will be given in detail of an algorithm from S100 to S500. To reiterate, the present disclosure relates to a technology for improving an error in which an object (i.e., the preceding vehicle 220 in FIG. 2) determined as occlusion due to crosstalk noise by reflected objects 240, 250, and 260 which are present in front of the vehicle 210 which is driving is excluded from a LIDAR real-time tracking target. With this in mind, a description will be given of each step (e.g., pre-processing, segmentation, clustering, and meta object selection, etc.).

In S100, a meta object may be generated according to the present disclosure. The pre-processing and segmentation process are described above. At this time, it is described that a maximum of 500 P-Boxes in which the occlusion effect does not occur are generated. In S100, LiDAR real-time tracking targets are limited to, for example, a maximum of 70 among the 5000 P-Boxes. The limited tracking targets are referred to as a “meta object” (e.g., high-confidence vehicle box, crossing pedestrian box, or dynamic object box, etc.).

As described above in FIG. 2, the present disclosure describes the possibility that the LiDAR and the AI module will incorrectly determine that the crosstalk noise of the traffic sign 240 occludes the preceding vehicle 220, because crosstalk noise has an influence on the point where the objects 240, 250, and 260, each of which has the large light reflectance, and the rear surface of the preceding vehicle 220 even after the preceding vehicle 220 passes through the point. Because the present disclosure prepares for the possibility of the error, that is, the case in which there occurs a case in which meta object information about the preceding vehicle 220 is not received as a tracking input, it generates objects associated with, for example, a maximum of 70 P-Boxes which are not occluded as a meta object (e.g., avoiding occluded road signs, reflective barriers, or sensor flares, etc.).

For reference, the reason why only the P-Box which is not occluded is generated as the meta object is because the object in which the occlusion effect occurs is sometimes an object in which the distance is relatively too far or the importance is low and in which LiDAR real-time tracking is not frequently required (e.g., distant street furniture, static roadside objects, or non-interacting background clutter, etc.). Thus, the case in which the occluded object is selected as the meta object in S100 is able to waste an AI computation resource unnecessary for clustering, post-processing, continuous tracking, or the like.

In addition, in the present disclosure, the “tracking” means that the AI module tracks a speed, a direction, a position, a size, shape information, or the like of the tracking object in real time based on sensing data of the LiDAR 120 (e.g., to predict lane changes, detect braking events, or avoid collisions, etc.).

In S200, an association (or an association operation) may be performed. As described above, in S100, a maximum of 70 P-Box objects may be generated as the meta object to use objects associated with a maximum of 70 P-Boxes as tracking objects. In S200, the meta object generated in S100 may be associated in units of, for example, 70 tracking objects determined to be tracked in S100. Herein, the “association” or the “association operation” refers to a task for determining a similarity between pieces of position or size information of objects indicated on LIDAR data (e.g., comparing centroid distance, box overlap ratio, or orientation difference, etc.) and determining whether meta objects generated by, for example, 70 are identical to the same objects as the 70 tracking objects determined to be tracked.

An “occlusion” meta object may be generated according to a certain condition (e.g., blocked sensor line-of-sight, missing data points, or sudden signal drop, etc.) and a confidence value of the occlusion meta object may be determined in S300 and may be determined as a target to perform an occlusion association operation in S400.

If subdividing S300 again, first of all, as shown in FIG. 3, it is determined whether a first condition, a second condition, and a third condition are satisfied in S310, S320, and S330, respectively (e.g., to verify tracking consistency, data uniqueness, and object visibility, etc.).

In the first condition in S310, it may be determined whether AI computation according to the present disclosure for the tracking object is already executed and an object associated with the tracking object should be less than or equal to one. In other words, the maximum of 70 tracking objects may be selected in S100. An object selected as a final tracking object and tracked in real time by LiDAR in S700 according to the present disclosure may be already included in the maximum of 70 tracking objects (e.g., a lead vehicle, adjacent lane vehicle, or crossing pedestrian, etc.). Furthermore, because even the object which does not pass through the algorithm to S700 according to the present disclosure may have no reason to go through the process to S700 if there are already 2 or more associated objects, in this case, NO determination may be made in S310 to move to S800, thus stopping executing the algorithm 300 according to the present disclosure for the object.

In the second condition in S320, there should be no meta object associated with the tracking object. In other words, in S200, the 70 meta objects may be generated to use the objects associated with, for example, the maximum of 70 P-Boxes as the tracking objects and it may be determined whether the tracking object and the meta object are the same objects. In S320, there may occur a case in which there is non-association (i.e., there is no association itself) or mis-association (if an associated similarity is low and it is incorrectly associated) upon association in S200 (e.g., due to occlusion, signal reflection, or partial object visibility, etc.). The present disclosure may make a YES determination in S320, if there is non-association or mis-association, and may move to S800 to stop executing the algorithm 300 according to the present disclosure for the object, if there is no non-association or mis-association.

As described above, the present disclosure is a technology for reacting to the case in which the object which is being tracked is excluded from a tracking target by crosstalk noise. If the tracking object is identical to the meta object in the second condition determination of S320, because this may be an error situation according to the occlusion effect, it is required that there are the crosstalk noise and the occlusion effect as a premise for application of the present disclosure in S320 (e.g., bright light reflections from metallic signs, temporary object disappearance, etc.).

The third condition in S330 may be to determine whether the tracking object is the preceding vehicle 220 on the basis of the host vehicle 210. Objective determination criteria for whether the tracking object is the preceding vehicle 220 should satisfy, for example, all the case in which the preceding vehicle 220 has an interval in direction D within 60 m compared to the host vehicle 210, the case in which the preceding vehicle 220 should be an object which is present within 2 m in a direction (e.g., a horizontal direction) perpendicular to direction D and has the occlusion effect, and the case in which the size of the preceding vehicle 220 is horizontally and vertically less than or equal to 6 m (e.g., a car, van, or small delivery truck, etc.).

In other words, if the road situation 200 of FIG. 2 is exemplified, a vehicle (not shown) preceding the host vehicle 210 above 60 m compared to the host vehicle 210 is unable to be the preceding vehicle 220 to be accurately tracked in the present disclosure. Herein, the measurement of the distance of 60 m is on the basis of a distance between a centerpoint of the host vehicle 210 and a centerpoint of the preceding vehicle 220. Furthermore, because an object out of 2 m in the horizontal direction on the basis of the centerpoint is able to be, for example, a vehicle in an opposite lane (e.g., a vehicle turning left or oncoming from a curve, etc.), detailed LiDAR tracking for safety of autonomous driving may fail to be required. Because the object in which the occlusion effect does not occur is not the target itself of the technical problem to be solved by the present disclosure, that alone is a reason for dissatisfaction with the third condition. Furthermore, if the size of the preceding object is horizontally/vertically greater than or equal to 6 m, the preceding object may be a movable object (e.g., an extra-large truck, a bus, a semi-trailer, or a dump truck, etc.) large enough not to have to worry about the occlusion effect or a massive structure (e.g., a tunnel entrance, a soundproof wall, or a bridge column, a section of the road where vehicle access is blocked due to asphalt construction, etc.). In any case, because it implies a situation which is far from the purpose of application of the present disclosure, any one of reasons for non-satisfaction should not be present to satisfy the third condition. Thus, if it is determined the third condition is not satisfied in S330, it may move to step 800 to stop executing the algorithm 300 according to the present disclosure for the object.

In S340, an “occlusion” meta object may be generated on the assumption that all the first to third conditions are satisfied (i.e., YES determination in all S310 to S330).

Of course, the occlusion meta object generated in S340 may be, for example, a meta object in which the occlusion effect occurs, according to the filtering in S310 to S330, which may be a vehicle with a size horizontally/vertically less than 6 m (e.g., a sedan, compact car, small SUV, or scooter, etc.), which is located within the distance of 60 m on the basis of the host vehicle and is not out of 2 m or more in the horizontal direction (i.e., from side to side).

However, one condition is further added to this to generate the occlusion meta object, only if the host vehicle 210 is currently driving “straight”. The “straight” may be defined as the case in which the curvature radius is greater than or equal to 400 m (e.g., highway cruising, express lane tracking, or rural straight-line driving, etc.), but not limited thereto. Furthermore, it is divided into both low-speed curvature and high-speed curvature for objective determination of driving straight to make determination according to the following equations.

First of all, for example, if the host vehicle 210 has a speed of 2 to 4 meters per second (e.g., in parking lots, traffic jams, or residential zones, etc.), it is regard as a “low speed”. Of course, low-speed determination may be made on the basis of other speed criteria. However, herein, a section of the speed of 2 to 4 meters per second is defined as a low-speed section, for convenience. A speed section except for the low-speed section is defined as a general section. In this case, Equation 1 below is derived using a current speed V of the host vehicle 210 and a steering angle δ of the host vehicle 210. Vₗₒₜ is a lateral speed. For reference, the steering angle refers to an angle between the vertical axis projection and the wheel surface of the vehicle and the cross line of the road surface (e.g., during tight turns, evasive maneuvers, or obstacle avoidance, etc.).

$${V}_{lat} ≅ V * tan ( δ ) \qquad [ Equation 1 ]$$

In other words, Equation 1 above has the meaning that multiplying the speed by the tangent value of the vehicle length (i.e., the wheelbase) may be seen as the lateral speed, if the current forward speed is relatively slow.

$${φ}_{slow} = \frac{V * tan ( δ )}{L} ≅ \frac{{V}_{lat}}{L} \qquad [ Equation 2 - 1 ]$$

$$\overline{φ} = ( ( 1 - α ) * {φ}_{slow} ) + ( α * φ ) \qquad [ Equation 2 - 2 ]$$

$${Curvature}_{slow} = \frac{V}{\overline{φ}} \qquad [ Equation 2 - 3 ]$$

Herein L is the wheelbase, φ_{slow} is the angular velocity (the yaw rate) when the host vehicle 210 is in the low-speed situation, α is the probability variable, and φ̅ is the estimated value of the angular velocity. In other words, the low-speed curvature Curvature_{slow} refers to the value level obtained by dividing the current speed by the estimated value of the angular velocity depending on Equation 2-3 above. For reference, the reciprocal of curvature is the curvature radius.

The case in which the speed V is in the general section complies with Equation 2-4 below.

$${Curvature}_{normal} = \frac{V}{φ} \qquad [ Equation 2 - 4 ]$$

The general curvature Curvatureₙₒᵣₘₐₗ refers to the value obtained by dividing the current speed of the vehicle by the measured angular velocity value depending on Equations 2-4 above.

According to the above description, in S340, the occlusion meta object may be generated only in the situation in which the vehicle 201 is driving straight (e.g., on a highway, arterial road, or rural route, etc.). In other words, the meta object generated in S100 may be searched. If the condition in S340 described above is satisfied, it is considered possible to register the occlusion meta object in the occlusion meta object pool to generate the occlusion meta object or the occlusion meta e.g., a predicted representation of an obscured car, pedestrian, or motorcycle, etc.).

If the occlusion meta object is generated, data conversion is required in a format capable of being compared with a track (e.g., for alignment, fusion, or classification, etc.). P-Box-related point information is updated, position and size information of the object is updated, and various flag values are initialized. For example, X values of [0] and [2] may be compared on the basis of the [3] point of minimum value X and a lower value and a midpoint may be output as reference points (e.g., for bounding box recalibration or object center estimation, etc.). In another case, X values of [1] and [3] may be compared on the basis of the [0] point of minimum value X and a lower value and a midpoint may be output as reference points. If a data size associated with the occlusion meta object is limited, occlusion metadata information is incorporated into a spare buffer portion in a buffer capable of processing the occlusion metadata (e.g., a circular buffer, delay buffer, or cache buffer, etc.).

In S350, a confidence value of the occlusion meta object may be determined. The maximum value of the confidence value may be set to, for example, 100 (e.g., for normalization, comparison, or thresholding, etc.). In S351, the confidence value may be evaluated based on the number of LiDAR points. For example, 30 points may be assigned, if the number of points is greater than or equal to 1000 (e.g., dense cluster regions or reflective surfaces). 20 points may be assigned, if the number of points is greater than or equal to 100. 10 points may be assigned, if the number of points is 50 to 100. 5 points may be assigned, if the number of points is 10 to 50.

In S352, a position confidence value may be determined. For example, 5 points may be assigned, if the occlusion meta object is located horizontally within 5 m (e.g., adjacent lanes, shoulder regions, or bike lanes, etc.). 5 points may also be assigned, if the occlusion meta object is within 5 m in the direction of driving (e.g., within forward braking or maneuvering range).

In S353, a confidence value of a contour shape may be determined. For example, 10 points may be assigned, if the number of contours is greater than or equal to 4 (e.g., rectangular cars, buses, or trucks), and 5 points may be assigned, if the number of contours is 2 to 4 (e.g., motorcycles, scooters, or strollers, etc.). The maximum number of contours in one object may be set to, for example, 6 (e.g., to represent boxy vehicles, trailers, or articulated machinery, etc.).

In S354, an L-shape is determined, that is, it may be determined whether the occlusion meta object has an L-shape (e.g., cornered vehicle geometry, bent trailer, or partially occluded sedan, etc.). For example, 20 points may be added to the occlusion meta object determined as having the L-shape.

In S355, a confidence value may be determined as a minimum point of the z-score. For example, if the z-score value indicating how far any data point is from the average of the data set is greater than or equal to 1.2 (e.g., indicating abnormal object size or position), −20 points may be assigned to the confidence value, that is, 20 points may be subtracted from the confidence value.

Of course, if the sum of the confidence values calculated in S351 to S355 should be 100, the determination of the confidence value in S350 is not completed. If a certain threshold of the confidence value is sometimes determined and a confidence value of the threshold or more is shown, it may be treated that the occlusion meta object satisfies the confidence value in S350. After S350, in S360, the occlusion meta object may be input as an “occlusion association” target (e.g., for track linking, prediction adjustment, or validation, etc.).

After S300, in S400, an association task may be performed with a non-association tracking object (e.g., unlinked car, missing pedestrian, or lost cyclist, etc.) for the occlusion meta object which is additionally input.

If subdividing S400, in S410, an association operation may be performed and the degree of association may be determined (e.g., using position, velocity, or shape similarity).

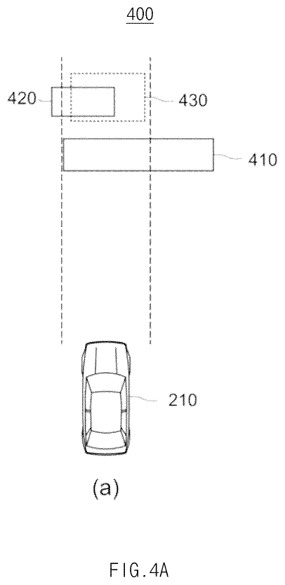

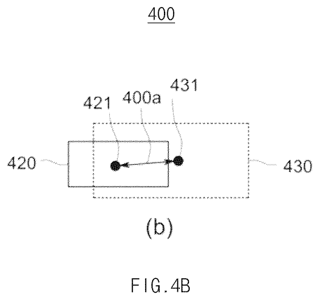

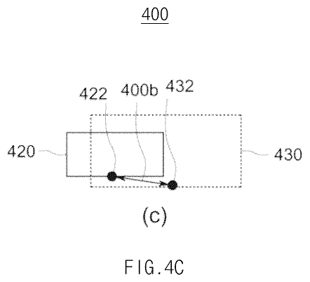

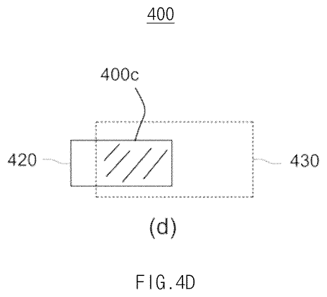

FIG. 4A, FIG. 4B, FIG. 4C, and FIG. 4D show exemplary drawings for describing a scheme for performing an association operation with a track according to the present disclosure. A situation 400 in which the degree of association is determined, as shown in FIG. 4A, FIG. 4B, FIG. 4C, and FIG. 4D, may be subdivided specific cases based on object configuration or positional variation (e.g., vehicle merging, lateral offset, or crossing trajectories, etc.). For example, FIG. 4A illustrates the exemplary situation 400 in which the degree of association is determined. There are a first P-Box 410 and a second P-Box 420 (e.g., representing detected objects like a car or a cyclist, etc.) in front of a vehicle 210 and a first track 430 corresponds to a portion shown in FIG. 4A. For instance, in FIG. 4A, a first P-Box 410 and second P-Box 420 are ahead of a vehicle 210, and a first track 430 overlaps with that area (e.g., past prediction or current LiDAR detection). The center of the first track 430 is illustrated as reference numeral 431 and the center of the second P-Box 420 is illustrated as reference numeral 421.

In other words, in S411, the degree of association may be determined on the basis of the centerpoint of the object (e.g., centroid, mass center, or bounding box midpoint, etc.). For example, as shown in FIG. 4B, a Mahalanobis distance 400a between the center 431 of the first track 430 and the center 421 of the second P-Box 420 may be measured to determine the degree of association. The Mahalanobis distance is a distance each case has for the center composed of average values of several variables. In other words, the value indicating how many times the standard deviation the difference between any value and the average value (e.g., accounting for correlations among variables like x, y, and speed) is as the distance is the Mahalanobis distance.

In S412, the Mahalanobis distance 400b may be calculated as, for example, FIG. 4C on the basis of tracking points 422 and 432.

In the present disclosure, the term “tracking point of the occlusion meta object” refers to a representative coordinate, such as the center point of a bounding box or the centroid of clustered sensor data, assigned to the occlusion meta object. This point is used as a reference position for evaluating the degree of association between the occlusion meta object and tracked objects, for example, by computing a positional correlation (e.g., using Mahalanobis distance) with the tracking data.

In S413, for example, as shown in FIG. 4D, the degree of association may be determined according to the size of an area that overlaps on the basis of an overlap region 400c. In S420, it may be determined whether “determination is made as being associated”, as a result of calculating the degree of association according to S411, S412, and S413. Only if the determination in S420 is YES, the process may proceed to S430 to verify the associated object. In other words, verification for the associated occlusion meta object and the tracking object may be performed in S430. An optimal associated object may be associated with, for example, a maximum of 10 occlusion meta objects per tracking object (e.g., in dense traffic situations or near intersections).

For example, in S430, a maximum of 10 associated meta candidate groups may be searched and 1 optimal associated object may be selected according to the number of found candidate groups. At this time, if the number of candidate groups is 1, the occlusion meta object may be output as an associated target. If the number of the candidate groups is greater than 1, it may move to S440 to execute optimal associated target determination according to a fifth condition, a “size condition” (e.g., filtering out objects too small or too large for valid association).

For example, in the optimal associated object determination condition, the width and the length should be greater than 1 m. This is to remove a small object, such as a tubular marker or a labacon (e.g., traffic cones, lane delineators, or temporary markers, etc.). Furthermore, if the size and the area of the object are most similar to the tracking object, it is selected as an optimal associated object. In addition, only if the maximum height of the point is less than or equal to 3 m, it may be selected as the optimal associated object. This is to remove a high-altitude object, such as a traffic sign installed too high (e.g., overhead gantries or signal poles, etc.). As another example, only if the number of points is greater than or equal to 10, it may be selected as the optimal associated object. This is to remove a small object, such as a tubular marker or a labacon. Of course, for example, only the object in which the confidence value of the result of the confidence value determination in S350 is greater than or equal to 30 may be set to be an output target.

To sum up, in S440, it may be determined whether the occlusion meta object associated with the tracking object has a similar characteristic to the tracking object. For example, only if all conditions, for example, if the object size is greater than 1 m, if there is the largest region in the associated object, if the maximum height is located to be less than or equal to 3 m, if the difference between the host vehicle 210 and the heading angle is less than or equal to 30 degrees (e.g., no sharp-angle discrepancy between the objects), if the number of points included in the object is greater than 10, and if the confidence value is greater than or equal to 30, should be satisfied, in S440, YES determination may be made.

If the YES determination is made in S440, in S450, the verified associated object may be input as an associated target (e.g., a vehicle, a pedestrian, or a bicycle, etc.). It may move to S500 to perform a tracking update for the tracking object, whose verification passed in S400 (e.g., the object meets all spatial, size, and confidence criteria). The tracking object which is not output in the related art may be normally output via post-processing of S600 and S700. Particularly, in S700, tracking information may be updated based on meta information for the object associated with the occlusion meta object among the tracking objects. Herein, speed information, direction information, position information, size information, shape information, or the Like (e.g., bounding box width, relative velocity, centroid location, or object silhouette, etc.) may be included in the tracking information.

According to the algorithm 300 of FIG. 3, if the present disclosure is not applied, there occurs a phenomenon in which tracking may be maintained only during about 3 frames using tracking information at the past time point, for the tracking object with which the meta object is not associated, and it is deleted from the tracking object from the fourth frame (e.g., when the preceding vehicle becomes temporarily invisible due to occlusion by a signboard, overpass, or large nearby vehicle, etc.). Of course, other than such a phenomenon, there is also concern that the error in heading and position information of the object will increase as the tracking error in the past frame is accumulated (e.g., misaligned trajectory, drifting location markers, or incorrect motion vector, etc.).

On the other hand, if the algorithm 300 of FIG. 3 is applied, it is possible for the tracking object which is not associated with the meta object to perform association with the occlusion meta object and it is possible for the object associated with the occlusion meta object to perform a tracking update on the basis of meta object at a current time point (e.g., maintaining lane awareness, estimating relative speed, or updating collision prediction metrics, etc.).

FIG. 5A shows an example of an error in object recognition due to crosstalk and an occlusion effect capable of occurring in the situation shown in FIG. 2. FIG. 5B shows an exemplary drawing of an experimental result in which object tracking is normally performed despite crosstalk and an occlusion effect by applying the present disclosure in a similar situation to FIG. 5A (e.g., the bounding box disappears, velocity vector is lost, or the object label is removed, etc.).

First of all, referring to FIG. 5A, a case 500a in which a preceding vehicle occluded due to a crosstalk phenomenon of a traffic sign on a motorway is not detected is illustrated. In other words, it may be seen that the preceding vehicle occluded due to the crosstalk phenomenon of the traffic sign is not recognized as a measured object and tracking fails due to it in FIG. 5A.

On the other hand, in a case 500b of FIG, 5B, it may be seen that the measured object is generated based on points which are not occluded although the preceding vehicle is occluded due to the crosstalk phenomenon of the traffic sign and an association operation is performed with the object which is not associated to maintain tracking (e.g., using reflected points from the lower bumper, wheelbase, or rear surface, etc.). In other words, it may be seen that the case in which the preceding vehicle occluded due to the crosstalk phenomenon is not recognized as the measured object and the tracking fails due to it is illustrated on the left of the case 500b and the case in which the measured object is generated based on the points which are not occluded although the preceding vehicle is occluded due to the crosstalk phenomenon of the traffic sign and the association operation is performed with the object which is not associated to maintain the tracking is illustrated on the right of the case 500b (e.g., recovery through occlusion meta inference, leveraging point-cloud continuity, or geometric approximation, etc.).

As described in FIGS. 2 to 5B, it is possible to react to the crosstalk phenomenon to accurately track the object. In other words, the present disclosure proposes an algorithm for generating a so-called meta object using LiDAR point information which is not clustered and performing an association operation based on it to maintain normal tracking performance, if the shape of the preceding object is occluded due to reflected object noise (e.g., from a traffic sign, guardrail, or reflective road marker, etc.) and the object is lost.

Furthermore, the present disclosure may additionally define a maximum of 5 types of objects for an object (e.g., a car, a bus, a motorcycle, a pedestrian, or a bicycle, etc.) (particularly, another vehicle which is driving in front of the same road) which is present near the driving vehicle as the object in which the occlusion effect occurs among the clustered P-Boxes (particularly, if there is an object with large light reflectance, such as a traffic sign, nearby) (e.g., dense point groups caused by LiDAR reflection) and may use it as data of the association operation, thus tracking a normal LiDAR object, even if the occlusion effect by crosstalk occurs. For example, a maximum of 5 objects (e.g., reference numeral 220, such as sedans, SUVs, buses, or small trucks, etc.) which are present near the host vehicle 210 among objects in which the occlusion effect occurs, except for 70 tracking inputs among 500 clustering boxes, are additionally used as associated data. An association task is performed with 5 objects which are stored only for the tracking object which is not associated with the meta object.

Finally, FIG. 6 shows an example of a computing system 1000 for autonomous vehicle control and object recognition computation according to an example of the present disclosure (e.g., for real-time object detection, tracking, or emergency decision-making, etc.).

Referring to FIG. 6, a computing system 1000 may include at least one processor 1100, a memory 1300, a user interface input device 1400, a user interface output device 1500, a storage 1600, and a network interface 1700, which are connected with each other via a bus 1200 (e.g., a system-on-chip interconnect or a high-speed communication bus, etc.).

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320 (e.g., DDR4, LPDDR5, or SRAM, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an example of the present disclosure, a method for extracting a preceding object in which an occlusion effect due to noise in data of a LiDAR point cloud occurs using an AI algorithm may include a first step of generating a meta object, a second step of performing an association operation for the meta object, a third step of generating an occlusion meta object, a fourth step of performing an association operation for the occlusion meta object, and a fifth step of updating track data to track the preceding object, after the association operation for the occlusion meta object.

In the method according to another example of the present disclosure, it may be determined whether to execute the third step depending on a first condition for checking whether a tracking object is already updated as an update target.

In the method according to another example of the present disclosure, it may be determined whether to execute the third step depending on a second condition for determining whether a meta object associated with the tracking object is already present, in addition to the first condition.

In the method according to another example of the present disclosure, it may be determined whether to execute the third step depending on a third condition about whether a position of the tracking object corresponds to a position of a preceding vehicle on the basis of an ego-vehicle loaded with LiDAR, in addition to the first condition and the second condition.

In the method according to another example of the present disclosure, it may be determined in the third step whether to generate the occlusion meta object depending on an additional condition about whether the ego-vehicle is driving straight, in additional to the first to third conditions.

In the method according to another example of the present disclosure, a box point update, a position and size information update, and one or more flag information initialization tasks may be performed, if generating the occlusion meta object.

In the method according to another example of the present disclosure, the third step may include a confidence value determination step of determining a confidence value for the occlusion meta object, after the occlusion meta object is generated.

In the method according to another example of the present disclosure, the confidence value determination step may include a point's number confidence value determination step.

In the method according to another example of the present disclosure, the confidence value determination step may include a position confidence value determination step.

In the method according to another example of the present disclosure, the confidence value determination step may include a contour shape confidence value determination step.

In the method according to another example of the present disclosure, the confidence value determination step may include an L-shape confidence value determination step.

In the method according to another example of the present disclosure, the confidence value determination step may include a z-score minimum point confidence value determination step.

In the method according to another example of the present disclosure, the fourth step may include a step of determining a degree of association on the basis of a centerpoint of an object.

In the method according to another example of the present disclosure, the fourth step may include a step of determining a degree of association on the basis of a tracking point.

In the method according to another example of the present disclosure, the fourth step may include a step of determining a degree of association on the basis of an overlap region.

In the method according to another example of the present disclosure, the fourth step may include a step of selecting an optimal associated object.

In the method according to another example of the present disclosure, the fourth step may include a step of selecting the optimal associated object based on at least one criterion among a width and length of an object, an area of the object, a height of the object, the number of points, and a predetermined confidence value threshold, if the number of meta candidate groups is greater than 1.

According to another example of the present disclosure, a system for extracting a preceding object in which an occlusion effect due to noise in data of a LiDAR point cloud occurs using an AI algorithm may include a processor loaded with an AI algorithm for analyzing a surrounding environment from point cloud data generated from LiDAR as an image processing module and a memory storing the point cloud data. The image processing module may execute a first step of generating a meta object, a second step of performing an association operation for the meta object, a third step of generating an occlusion meta object, a fourth step of performing an association operation for the occlusion meta object, and a fifth step of updating track data to track the preceding object, after the association operation for the occlusion meta object.

As a predicted bounding box (P-Box) for recognizing an object using point clustering due to characteristics of the LIDAR sensor is generated and the load for the operation time of the algorithm occurs in the computation and tracking process associated with the LiDAR point and the P-Box, the tracking and object recognition update by AI is performed on the basis of the object which is not occluded based on the free space.

If occlusion occurs based on the free space, due to crosstalk noise which occurs due to the reflected object which is the edge case according to characteristics of the LiDAR sensor, the preceding object (e.g., a vehicle in front of the road or the like) may be lost. As the shape of the object is recognized as being inaccurate over the loss time and LiDAR tracking performance about a heading, a position, a speed, or the like of the object is degraded, this may have an influence on system stability.

The LiDAR sensor emits laser and estimates a distance depending to reflection intensity at which the laser is reflected from the target to return. If the laser is reflected from the object with high reflection intensity, such as a reflector on the road, noise actually occurs in a region where the laser is not received (i.e., where the laser is reflected to return). Thus, that false measurement data different from the reality occurs is referred to as a crosstalk phenomenon.

Particularly, if the traffic sign (with relatively large light reflectance) is located with the vehicle route and the preceding vehicle is driving in front of the route, there may occur a phenomenon in which crosstalk noise is added to point data and the P-Box about the preceding vehicle at a time point when the frequency of occurrence of crosstalk in the vertical direction by the traffic sign is large and the preceding vehicle passes through the position of the traffic sign to delete a meta object.

Furthermore, if crosstalk noise in the vertical direction by the traffic sign has an influence on the rear surface of the vehicle even after the preceding vehicle passes through the point where it overlaps with the traffic sign, as it is incorrectly recognized that the crosstalk noise of the traffic sign continuously occludes the preceding vehicle, meta object information about the preceding vehicle is not tracked.

According to the present disclosure, it is possible to react to the crosstalk phenomenon to accurately track the object. In other words, the present disclosure proposes an algorithm for generating a so-called meta object using LiDAR point information which is not clustered, and performing an association operation based on it to maintain normal tracking performance, if the shape of the preceding object is occluded due to reflected object noise and the object is lost.

Furthermore, the present disclosure may additionally define a maximum of 5 types of objects for an object which is present near the driving vehicle as the object in which the occlusion effect occurs among the clustered P-Boxes (particularly, if there is an object with large Light reflectance, such as a traffic sign, nearby) and may use it as data of the association operation, thus tracking a normal LiDAR object, even if the occlusion effect by crosstalk occurs.

In addition, those skilled in the air may understand various effects other than the effects described above from the present disclosure, via the detailed description of the present disclosure and the accompanying drawings.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A method performed by an apparatus of a vehicle, the method comprising:
generating, based on point cloud data from a sensor of the vehicle, a meta object;
associating the meta object with a previously detected object;
generating, based on a portion of the point cloud data affected by an occlusion effect, an occlusion meta object;
associating the occlusion meta object with the previously detected object;
updating, based on the associating of the meta object and the associating of the occlusion meta object, track data to track an object located ahead of the vehicle;
outputting a signal indicating the updated track data; and
controlling, based on the signal, autonomous driving of the vehicle.

2. The method of claim 1, wherein the generating of the occlusion meta object is performed based on a determination whether a tracking object is already designated as an update target, and
wherein the generating of the occlusion meta object comprises using an artificial intelligent algorithm to determine, based on noise in the point cloud data, whether the occlusion effect has occurred.

3. The method of claim 2, wherein the generating of the occlusion meta object is performed further based on a determination whether a meta object associated with the tracking object is already present.

4. The method of claim 3, wherein the generating of the occlusion meta object is performed further based on a determination whether a position of the tracking object corresponds to a position of a preceding vehicle, and wherein the determination of whether the position of the tracking object corresponds to the position of the preceding vehicle is made based on position information of an ego-vehicle equipped with a sensor.

5. The method of claim 4, wherein the generating of the occlusion meta object is performed further based on a determination whether the ego-vehicle is driving straight.

6. The method of claim 5, wherein the generating of the occlusion meta object comprises:
updating point information of a box representing the occlusion meta object,
updating position and size information associated with the occlusion meta object, and
initializing one or more flag information associated with the occlusion meta object.

7. The method of claim 5, wherein the generating of the occlusion meta object comprises determining a confidence value of the occlusion meta object.

8. The method of claim 7, wherein the determining of the confidence value comprises determining:
a number of sensor points associated with the occlusion meta object, and
setting, based on the number of sensor points, the confidence value.

9. The method of claim 8, wherein the determining of the confidence value comprises determining a position-based confidence value.

10. The method of claim 9, wherein the determining of the confidence value comprises determining a contour shape-based confidence value.

11. The method of claim 10, wherein the determining of the confidence value comprises an L-shape-based confidence value.

12. The method of claim 11, wherein the determining of the confidence value comprises determining, based on a z-score, a minimum point confidence value.

13. The method of claim 1, wherein the associating of the occlusion meta object comprises determining a degree of association based on a center point of the occlusion meta object and a center point of the previously detected object.

14. The method of claim 13, wherein the associating of the occlusion meta object comprises determining, based on a presentative tracking point of the occlusion meta object, the degree of association.

15. The method of claim 14, wherein the determining of the degree of association comprises determining, based on an overlap region between bounding boxes of the occlusion meta object and the previously detected object, the degree of association.

16. The method of claim 15, wherein the associating of the occlusion meta object comprises selecting, from among a plurality of previously detected objects, an associated object having a highest degree of association.

17. The method of claim 16, wherein the selecting of the associated object having the highest degree of association comprises selecting the associated object based on at least one criterion among:
a width and length of the associated object,
an area of the associated object,
a height of the associated object,
a number of points included the associated object, and
a confidence value of the associated object satisfying a predetermined confidence value threshold, based on a number of meta candidate groups being greater than one.

18. A vehicle comprising:
a sensor;
a processor; and
a memory storing at least one instruction that, when executed by the processor communicating with the memory, is configured to cause the vehicle to:
obtain point cloud data generated by the sensor,
based on a portion of the point cloud data affected by noise, generate an occlusion meta object, wherein the occlusion meta object represents a partially detected object located ahead of the vehicle, and wherein the noise is caused by signal interference from at least one object located in an area scanned by the sensor,
determine whether the occlusion meta object satisfies predefined criteria, wherein the predefined criteria are based on at least a distance and orientation of the occlusion meta object relative to the vehicle,
based on determining that the occlusion meta object satisfies the predefined criteria, associate the occlusion meta object with a tracking object, wherein the tracking object corresponds to a previously detected object, and wherein the tracking object is not currently associated with any previously generated occlusion meta object, and
update, based on the associated occlusion meta object, tracking information of the tracking object such that the tracking object is tracked based on the updated tracking information, despite the noise.

19. The vehicle of claim 18, wherein the noise comprises crosstalk noise,
wherein the at least one instruction, when executed by the processor communicating with the memory, is configured to cause the vehicle to:
determine a confidence value of the occlusion meta object,
wherein the confidence value is based on a number of sensor points in the portion of the point cloud data affected by the crosstalk noise, and
wherein the determination of whether the occlusion meta object satisfies the predefined criteria is further based on the confidence value.

20. The vehicle of claim 18, wherein the at least one instruction, when executed by the processor communicating with the memory, is configured to cause the vehicle to:
associate the occlusion meta object with a tracking object by comparing position or size information of the occlusion meta object and the tracking object to determine whether the occlusion meta object corresponds to the same object as the tracking object,
output a signal indicating the tracking information, and
control, based on the signal, autonomous driving of the vehicle.
